(19) United States
(12) Patent Application Publication
(10) Pub. No.: US 2009/0132961 A1
(43) Pub. Date: May 21, 2009

(54) TUNABLE SYSTEM FOR GEOGRAPHICALLY-BASED ONLINE ADVERTISING

(75) Inventor: DAVID J. P. BAAR, Vancouver (CA)

Correspondence Address: McCarthy Tetrault LLP, Box 48, Suite #4700 Toronto Dominion Bank Tower, TORONTO, ON, M5K 1E6, CA

(73) Assignee: Idelix Software Inc., Vancouver (CA)

(21) Appl. No.: 12/268,693

(22) Filed: Nov. 11, 2008

Related U.S. Application Data
(60) Provisional application No. 60/988,455, filed on Nov. 16, 2007.

(51) Int. Cl. G06F 3/048; G06Q 30/00

(52) U.S. Cl. 715/810; 705/14

(57) ABSTRACT

A method for presenting advertisement images on a display screen, comprising: subdividing a map image into a plurality of geographic regions; associating first and second advertisement images with a region within the plurality of geographic regions, the first advertisement image being associated with a first advertiser and the second advertisement image being associated with a second advertiser; receiving a signal indicative of a region-of-interest, the region-of-interest corresponding to the region; selecting an advertisement image for the region from among the first and second advertisement images; generating a presentation of the region-of-interest, the presentation including a view of the advertisement image; and, displaying the presentation on the display screen.

This application claims priority from U.S. Provisional Patent Application No. 60/988,455, filed Nov. 16, 2007, and incorporated herein by reference.

### FIELD OF THE INVENTION

This invention relates to the field of computer graphics processing and online advertising, and more specifically, to a method and system for generating and adjusting presentations for geographically-based and time-based online advertising applications.

### BACKGROUND OF THE INVENTION

The growth of the Internet and online map presentation technologies has resulted in broad availability of online and interactive presentations of maps and geographically relevant photographic images. Online geographic data presentations such as maps and images also present new opportunities for online advertising and for geographically-based advertising methods and systems. Some such methods and systems are described in United States Patent Application Publication No. 2007/0165050, which is incorporated herein by reference, in which presentation of particular advertisements is coupled to an expression of user interest in a specific geographic region, area, or location (e.g., a region-of-interest, area-of-interest, location-of-interest, etc.). However, for example, such methods and systems to do not fully address the distribution of regions to multiple advertisers (i.e., the “large advertiser dominance problem”).

A need therefore exists for an improved method and system for generating and adjusting presentations for geographically-based online advertising applications. Accordingly, a solution that addresses, at least in part, the above and other shortcomings is desired.

### SUMMARY OF THE INVENTION

According to one aspect of the invention, there is provided a method for presenting advertisement images on a display screen, comprising: subdividing a map image into a plurality of geographic regions; associating first and second advertisement images with a region within the plurality of geographic regions, the first advertisement image being associated with a first advertiser and the second advertisement image being associated with a second advertiser; receiving a signal indicative of a region-of-interest, the region-of-interest corresponding to the region; selecting an advertisement image for the region from among the first and second advertisement images; generating a presentation of the region-of-interest, the presentation including a view of the advertisement image; and, displaying the presentation on the display screen.

According to another aspect of the invention, there is provided a method for presenting advertisement images on a display screen, comprising: subdividing a map image into first and second pluralities of geographic regions, the first and second pluralities of geographic regions having corresponding regions, whereby a region within the first plurality of geographic regions is included within the second plurality of geographic regions; associating a first advertisement image with the region within the first plurality of geographic regions and associating a second advertisement image with the region within the second plurality of geographic regions, the first advertisement image being associated with a first advertiser and the second advertisement image being associated with a second advertiser; receiving a signal indicative of a region-of-interest, the region-of-interest corresponding to the region; selecting an advertisement image for the region from among the first and second advertisement images; generating a presentation of the region-of-interest, the presentation including a view of the advertisement image; and, displaying the presentation on the display screen.

In accordance with further aspects of the present invention there is provided an apparatus such as a data processing system, a method for adapting this system, as well as articles of manufacture such as a computer readable medium having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a data processing system in accordance with an embodiment of the invention;

FIG. 2 is a screen capture illustrating a first advertisement presentation in accordance with an embodiment of the invention;

FIG. 3 is a screen capture illustrating a second advertisement presentation in accordance with an embodiment of the invention;

FIG. 4 is a schematic diagram illustrating a tunable geographically-based advertising system in accordance with an embodiment of the invention;

FIG. 5 is a partial screen capture illustrating a graphical user interface having lens control elements for adjusting detail-in-context presentations in accordance with an embodiment of the invention;

FIG. 6 is a flow chart illustrating operations of modules within a data processing system for presenting advertisement images on a display screen in accordance with an embodiment of the invention; and,

FIG. 7 is a flow chart illustrating operations of modules within a data processing system for presenting advertisement images on a display screen in accordance with another embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and methods have not been described or shown in detail in order not to obscure the invention. The term “data processing system” is used herein to refer to any machine for processing data, including the computer systems and network arrangements described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention. The present invention may also be implemented in hardware.

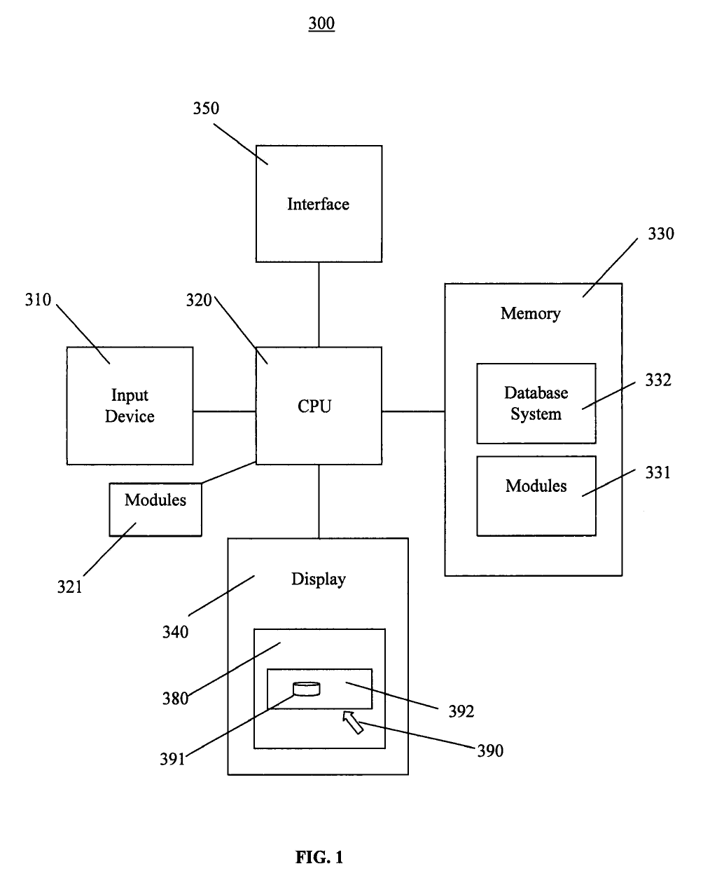

FIG. 1 is a block diagram illustrating a data processing system 300 in accordance with an embodiment of the invention. The data processing system 300 is suitable for generating, displaying, and adjusting presentations in conjunction with a graphical user interface (“GUI”), as described below. The data processing system 300 may be a client and/or server in a client/server system. For example, the data processing system 300 may be a server system or a personal computer (“PC”) system. The data processing system 300 may also be a wireless device or other portable or handheld device. The data processing system 300 includes an input device 310, a central processing unit (“CPU”) 320, memory 330, a display 340, and an interface device 350. The input device 310 may include a keyboard, a mouse, a trackball, a touch sensitive surface or screen, a position tracking device, an eye tracking device, or a similar device. The display 340 may include a computer screen, television screen, display screen, terminal device, a touch sensitive display surface or screen, or a hardcopy producing output device such as a printer or plotter. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (not shown) over a network (not shown) via the interface device 350. For example, the interface device 350 may include an interface to a network such as the Internet and/or another wired or wireless network. Thus, the data processing system 300 may be linked to other data processing systems by the network. The CPU 320 may include or be operatively coupled to dedicated coprocessors, memory devices, or other hardware modules 321. The CPU 320 is operatively coupled to the memory 330 which stores an operating system (not shown) for general management of the system 300. The CPU 320 is operatively coupled to the input device 310 for receiving user commands or queries and for displaying the results of these commands or queries to the user on the display 340. Commands and queries may also be received via the interface device 350 and results may be transmitted via the interface device 350. The data processing system 300 may include a database system 332 for storing data and programming information. The database system 332 may include a database management system and a database and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the invention.

Thus, the data processing system 300 includes computer executable programmed instructions for directing the system 300 to implement the embodiments of the present invention. The programmed instructions may be embodied in one or more hardware modules 321 or software modules 331 resident in the memory 330 of the data processing system 300 or elsewhere (e.g., 320). Alternatively, the programmed instructions may be embodied on a computer readable medium (e.g., a compact disk (“CD”), a floppy disk, etc.) which may be used for transporting the programmed instructions to the memory 330 of the data processing system 300. Alternatively, the programmed instructions may be embedded in a computer-readable signal or signal-bearing medium that is uploaded to a network by a vendor or supplier of the programmed instructions, and this signal or signal-bearing medium may be downloaded through an interface (e.g., 350) to the data processing system 300 from the network by end users or potential buyers.

A user may interact with the data processing system 300 and its hardware and software modules 321, 331 using a graphical user interface (“GUI”) 380. The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input device 310 such as a mouse. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse) 310 to position a pointer or cursor 390 over an object (e.g., an icon) 391 and by “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

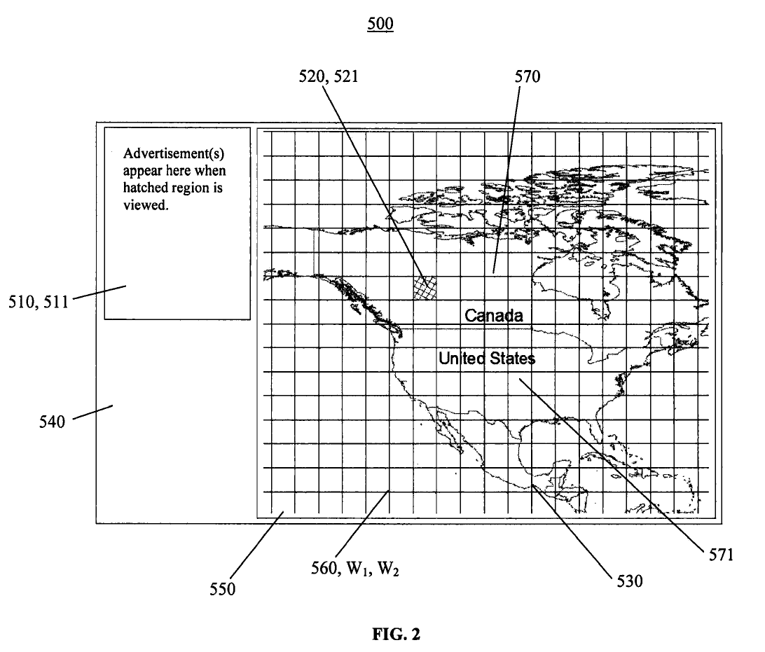

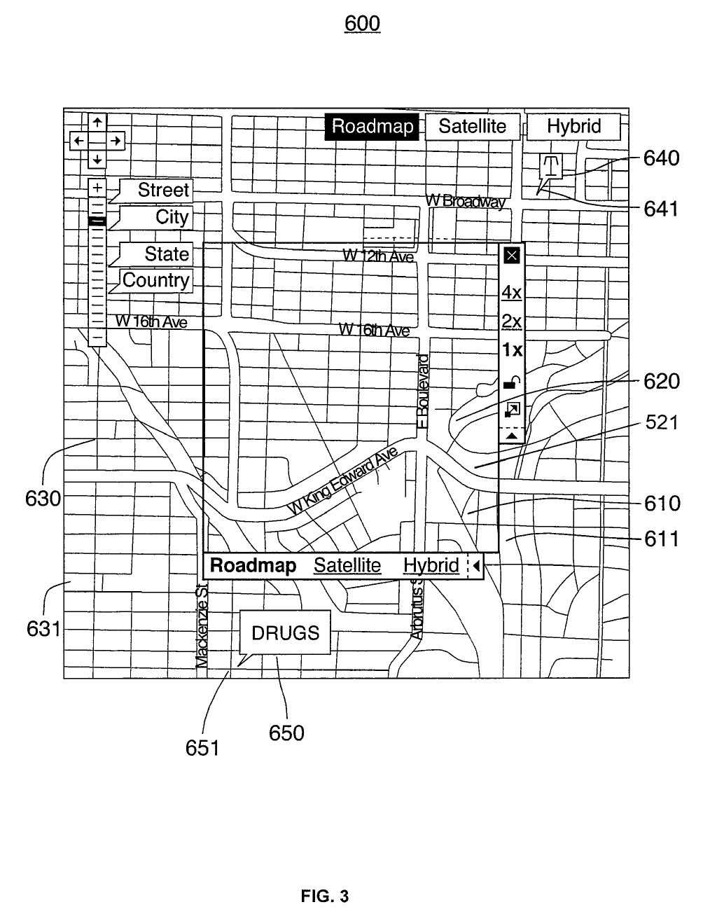

FIG. 2 is a screen capture illustrating a first advertisement presentation 500 in accordance with an embodiment of the invention. FIG. 2 may be used to illustrate a method for geographically-based online advertising in accordance with an embodiment of the invention. Referring to FIG. 2, an advertiser pays to have an advertisement 510 (or advertisements 510, 511) appear when a user later views a region or area 520 (shown as hatched in FIG. 2) on a map 530. According to one embodiment, prior to the user seeing this presentation 500, persons or corporations (i.e., advertisers) wishing to purchase space for advertisement presentation purchase from an advertising host or vendor the right or service of having a specific advertisement 510 appear when a given geographic region (i.e., a region-of-interest) or area 520 on a map 530 is later viewed, either in whole or in part, by a user on the user's display screen 340. Then, when the user later views the area or region 520, the advertisement 510 is presented in the presentation 500. According to one embodiment, the advertisement 510 may appear in a separate advertisement view or window 540 as shown in FIG. 2. According to another embodiment, the advertisement 510 may be presented using a window, overlay, or transparency (not shown) over the map 530 in the map view or window 550. According to another embodiment, other means of advertisement presentation may be used (e.g., see FIG. 3).

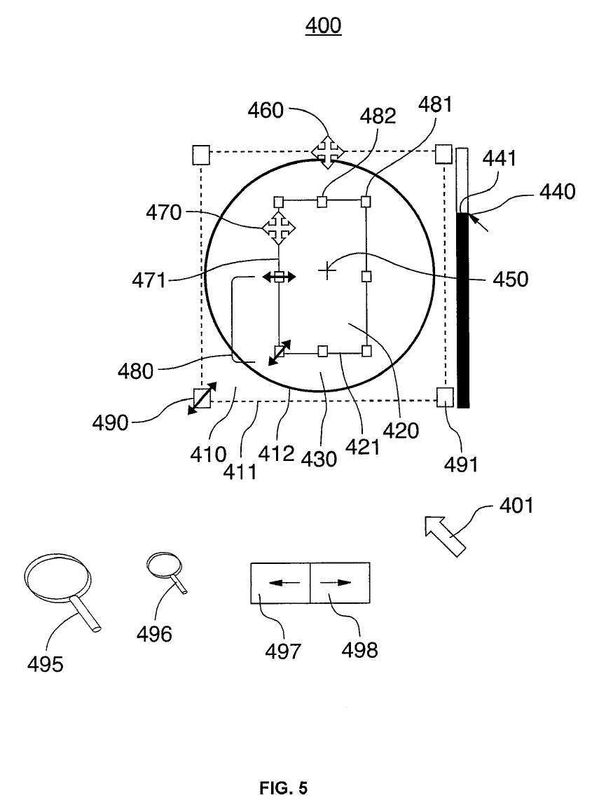

According to one embodiment, the user is provided with the ability to view the map 530 using an inset magnifier (610 in FIG. 3) or a detail-in-context lens (410 in FIG. 5) both as described below. In this embodiment, the advertisement 510 may be presented when the user moves the magnifier or lens over any part of the specified area or region 520. According to one embodiment, the advertisement 510 may be presented in a separate viewing area, view, or window 540 adjacent to the map 530. According to another embodiment, the advertisement 510 may be presented adjacent to, or overlaid on, the inset magnifier 610 or lens 410 in the map view or window 550.

According to one embodiment, an advertising vendor or host may sell advertising services (e.g., 510) to one or more advertisers for one or more geographic areas or regions (e.g., 520). In this embodiment, a map such as a world map or country map (e.g., 530) may be subdivided into a grid 560 and advertising services may be sold for presenting advertisements (e.g., 510) with respect to each unit 520 of the grid 560. According to another embodiment, the advertising vendor may sell advertising services on the basis of coverage of a specific (or predetermined) geographic area such as a city, state, province, or country (e.g., Canada 570, the United States 571, etc.). According to another embodiment, the advertising services offered for sale may be sold on a temporal as well as a geographic basis. For example, an advertiser may purchase from the advertising vendor an advertising service providing for the display of a particular advertisement (e.g., 510) for a particular period of time (e.g., a prime Internet usage period, a weekday, a month, etc.). The advertising services would pertain to a particular geographic area or region (e.g., 520, 570, 571) and appropriate advertisements (e.g., 510, 511) would be presented when a user (i.e., a customer of the advertiser) views the particular geographic area or region (i.e., a region-of-interest to the user). When the user views the particular geographic area or region, the advertisement(s) 510, 511 may be presented to the user either in a main map view or window 550, advertisement view or window 540, or within the extent of an inset magnifier or a detail-in-context lens presented to the user on the user's display screen 340 intersects (or is positioned over) that area or region 520, 570, 571.

One of the business considerations with respect to the above is the pricing to be charged for the presentation of advertisements 510, 511 associated with a particular area 520. For example, one would expect that a particular geographic region such as a major city or country (e.g., the United States 571) would have more frequent user traffic and hence would be of more value to advertisers than a remote region such as Antarctica. As such, according to one embodiment, advertising services may be sold on a per-view basis. According to another embodiment, advertising services may be sold through an auction process in which the right to have an advertisement appear when the user views a particular region is won by the highest bidder for that region. In this case, a per view price may also be charged after the right to present an advertisement is purchased via auction.

According to one embodiment, the displayed advertisement image 510 may change with scale. That is, if the scale of the map image 530 changes or is adjusted, a different advertisement image 511 may be presented (i.e., one with different content), with rights to regions at specific presentation scales having previously been sold to advertisers.

Thus, embodiments of the present invention, as described above, may be considered as methods for the sale of “virtual real estate” for advertising purposes, wherein the real estate of the globe (or a given portion of the globe) is subdivided (e.g., 560) and sold based on the presentation of specific advertisements (e.g., 510) when a predetermined geographic region (e.g., 520) is viewed by a user in whole or in part in a main map view or window 550, or in an inset magnifier, or in a detail-in-context lens.

FIG. 3 is a screen capture illustrating a second advertisement presentation 600 in accordance with an embodiment of the invention. As described above and shown in FIGS. 1-2, advertisers are provided with the option to buy regions or map tiles 520 based on the geo-coordinates of a company location, business location, or other location. In addition, advertisers are provided with the option of presenting one or more pushpins 640, 650 or other graphical indicators on a map 630 at locations 641, 651 of businesses belonging to or associated with the advertiser, FIG. 3 shows geo-located advertisements 640, 650 for the case of a single business location 641, 651 for each of two advertisers. In this embodiment, first and second advertisements 640, 650 appear in a peripheral area 631 of the map 630 (i.e., outside of an inset magnifier 610 presented for the map 630) and the locations 641, 651 are based on their actual geo-coordinates. Of course, the advertisements 640, 650 may also appear within 620 the inset magnifier 610.

In FIG. 3, the inset magnifier 610 is applied to a region-of-interest 521 in the map 630. The inset magnifier 610 has an associated graphical user interface 611 for adjusting the magnification (e.g., “1×”, “2×”, “4×”, etc.), extent, content (e.g., roadmap image, satellite image, hybrid image, etc.), etc., of the magnified or focal region 620 within the inset magnifier 610. In FIG. 3, a magnification level of “1×” (i.e., no magnification) has been applied to the region-of-interest 521 by the inset magnifier 610. In general, the region-of-interest 521 may fall within or otherwise correspond to a map tile or region 520.

Among other things, the present invention is directed toward the “large advertiser dominance problem”. In a geographically-based online advertising system such as that of United States Patent Application Publication No. 2007/0165050, a representation of the world or map 530 is divided up into tiles 520 at one or more specific scales, and advertisers obtain rights for their advertisements 510, 511, 640, 650 to be displayed by “leasing” or “buying” a desired tile (or tiles) 520 from the advertising vendor. Subsequently, a given advertiser's advertisement (e.g., 510, 640) may be displayed in a map presentation (e.g., 500, 600) or other presentation, when a user makes an expression of interest in a location 521 that falls within the corresponding leased tile (or tiles) 520, such as by interacting with a map presentation over the Internet in which the area corresponding to the tile (or tiles) 520 is at least partially displayed, or by using a global positioning system (“GPS”) device or other device with locating capabilities within the area covered by the leased tile (or tiles) 520. However, in such a geographically-based advertising system, if no restrictions are placed on the number of tiles 520 that can be purchased by a given advertiser or business entity, a large advertiser can, for example, obtain a local or larger scale dominance of advertising presentation by leasing a large number of tiles 520 in a given area. This then means that the advertising system favours large advertisers, since small businesses wishing to advertise can be blocked from leasing tiles 520 near their businesses if a large advertiser has already leased these tiles 520.

According to one embodiment, the large advertiser dominance problem may be at least partially addressed by the use of rules. In this embodiment, rules such as limits to the maximum number of tiles 520 that can be leased or purchased by a given advertiser, or similarly, limits to the maximum total area of tiles that can be leased or purchased by the advertiser, are incorporated in the advertising system 300. This reduces the large advertiser dominance problem and allows a large number of small businesses to lease or purchase tiles 520 covering map areas near their business addresses. Rules may also be incorporated to restrict advertisers from advertising in areas that are far from their registered business addresses (i.e., far from locations on the map 530, 630 associated with the advertiser). This method may, of course, prevent the advertising vendor from making large lease sales to large advertisers.

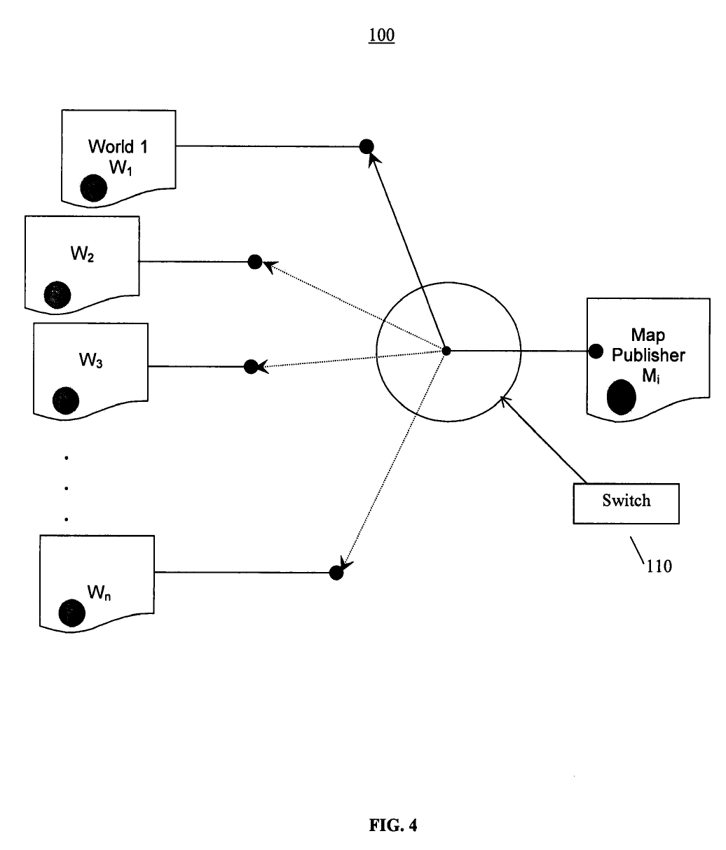

According to another embodiment, the large advertiser dominance problem may be at least partially addressed by the use of alternate “advertising worlds”. FIG. 4 is a schematic diagram illustrating a tunable geographically-based advertising system 100 in accordance with an embodiment of the invention. According to this embodiment, two or more “advertising worlds” W₁-Wₙ (i.e., map subdivisions) are provided, in which tiles 520 are leased or sold separately for each world (e.g., W₁, W₂ in FIG. 2), and independent sets of rules are applied in each world W₁, W₂, such as rules regarding the maximum number of tiles 520 that can be leased. Then, in the actual presentation (e.g., 500, 600) of the advertisement (e.g., 510, 640), when an opportunity to present an advertisement 510, 640 occurs, the system 100 selects 110 an advertisement (e.g., 510) from a particular world (e.g., W₁), based on a probabilistic weighting of the worlds W₁, W₂, which can be varied on demand, or by a preset formula, or by another means of selection. This is shown schematically in FIG. 4. This admixture of advertising worlds W₁, W₂ represents a tunable advertising system 100 (i.e., within the data processing system 300) that can be optimized between large business advertisers and small business advertisers. Tunable variables may include the following:
Pᵢ: The probability of pulling an advertisement from world Wᵢ (“dwell time”);
Q_{max,i}: The number of tiles 520 allowed for lease or purchase by one advertiser (e.g., in world Wᵢ); and,
Tᵢ: The maximum run time for an advertisement in world Wᵢ.

According to one embodiment, a detail-in-context lens 410 may be used rather than the inset magnifier 610 shown in FIG. 3. The term “detail-in-context” refers to the magnification of a particular region-of-interest (the “detail”) in an original image while preserving visibility of the surrounding information (the “context”). A presentation including a detail-in-context lens may be referred to as a detail-in-context presentation. In general, a detail-in-context presentation may be considered as a distorted view of a portion of an original image where the distortion is the result of the application of a “lens” like distortion function to the original image. Detail-in-context presentations may be generated using a variety of the methods. A detailed review of various detail-in-context presentation methods may be found in a publication by Marianne S. T. Carpendale, entitled “A Framework for Elastic Presentation Space” (Carpendale, Marianne S. T., A Framework for Elastic Presentation Space (Burnaby, British Columbia: Simon Fraser University, 1999)), and incorporated herein by reference. Reference may also be made to U.S. Pat. Nos. 7,197,719 and 7,213,214, which are incorporated herein by reference.

According to one embodiment, a detail-in-context presentation may be generated as follows. First, the undistorted original image is located in a base plane of a three-dimensional perspective viewing volume or frustum. A viewpoint is typically located above a centre point of a view plane which is located above the base plane. Points of the original image in the base plane are displaced upward onto a distorted surface or lens which is defined by a three-dimensional distortion function (e.g., the lens may have a truncated pyramid shape having a flat rectangular top surrounded by four inclined trapezoidal sides). The displaced points are then perspectively projected onto the view plane to generate the presentation. The direction of the projection may be in the direction of a line constructed through a point in the base plane through a point in the focal region of the lens. The projection may be in a direction that is viewer-aligned (i.e., the point in the base plane, the point in the focal region, and the viewpoint are collinear). The resultant combination of magnification and compression of the original image as seen in the view plane from the viewpoint results in a lens-like effect similar to that of a magnifying glass applied to the original image. In general, the lens has a “focal region” (e.g., the flat rectangular top of a lens having a truncated pyramid shape) for the region-of-interest. The focal region has an elevation (or magnification) that produces a corresponding “magnified region” for the region-of-interest upon projection onto the view plane. At least partially surrounding the focal region is a “shoulder region” (e.g., the four inclined trapezoidal sides of a lens having a truncated pyramid shape) where the elevation (or magnification) decreases from that of the focal region to that of the original image surrounding the shoulder region and which produces a corresponding at least partially “compressed region” upon projection onto the view plane.

FIG. 5 is a partial screen capture illustrating a GUI 400 having lens control elements for adjusting detail-in-context presentations in accordance with an embodiment of the invention. The lens control elements of the GUI 400 are adjusted by the user via an input device 310 to control the characteristics of the lens 410 (shown after projection in FIG. 5) used to generate the detail-in-context presentation. Using the input device 310 (e.g., a mouse), a user adjusts parameters of the lens 410 using icons and scroll bars of the GUI 400 that are displayed over the magnified and compressed regions 420, 430 on the display screen 340. Signals representing input device 310 movements and selections are transmitted to the CPU 320 of the data processing system 300 where they are translated into instructions for lens control.

The lens 410 (shown after projection in FIG. 5) includes a focal region 420 (shown after projection in FIG. 5) which produces a magnified region 420 after projection at least partially surrounded by a shoulder region 430 (shown after projection in FIG. 5) which produces an at least partially compressed region 430 after projection. In FIG. 5, the lens 410 is shown with a rectangular shaped focal region 420 lying near the center of the lens 410 and with a circular shaped shoulder region 430 surrounding the focal region 420. However, the lens 410 and its focal and shoulder regions 420, 430 may have any desired shape (e.g., square, rectangular, circular, etc.).

The GUI 400 may include the following lens control elements: move, pickup, resize shoulder region, resize focal region, fold, magnify, zoom, and scoop. Each of these lens control elements may have at least one lens control icon or alternate cursor icon associated with it. In general, when a lens 410 is selected by a user through a point and click operation, the following lens control icons may be displayed over the lens 410: pickup icon 450, lens outline icon 412, shoulder region bounding rectangle icon 411, focal region bounding rectangle icon 421, handle icons 481, 482, 491, magnify slide bar icon 440, zoom icon 495, and scoop slide bar icon (not shown). Typically, these icons are displayed simultaneously after selection of the lens 410. In addition, when the cursor 401 is located within the extent of a selected lens 410, an alternate cursor icon 460, 470, 480, 490, 495 may be displayed over the lens 410 to replace the cursor 401 or may be displayed in combination with the cursor 401. These lens control elements, corresponding icons, and their effects on the characteristics of a lens 410 are described below with reference to FIG. 5.

In general, when a lens 410 is selected by a point and click operation, bounding rectangle icons 411, 421 are displayed surrounding the focal region 420 and shoulder region 430 of the selected lens 410 to indicate that the lens 410 has been selected. With respect to the bounding rectangles 411, 421 one might view them as glass windows enclosing the focal region 420 and the shoulder region 430, respectively. The bounding rectangles 411, 421 include handle icons 481, 482, 491 allowing for direct manipulation of the focal region 420 and the shoulder region 430 as will be explained below. Thus, the bounding rectangles 411, 421 not only inform the user that the lens 410 has been selected, but also provide the user with indications as to what manipulation operations might be possible for the selected lens 410 though use of the displayed handles 481, 482, 491. Note that the bounding rectangle 411, 421 may be of any shape.

Moreover, the cursor 401 provides a visual cue indicating the nature of an available lens control element. As such, the cursor 401 will generally change in form by simply pointing to a different lens control icon 450, 412, 411, 421, 481, 482, 491, 440. For example, when resizing the shoulder region 430 of a lens 410 using a corner handle 491, the cursor 401 may change form to a resize icon 490 once it is pointed at (i.e., positioned over) the corner handle 491. The cursor 401 may remain in the form of the resize icon 490 until the cursor 401 has been moved away from the corner handle 491.

Lateral movement of a lens 410 is provided by the move lens control element of the GUI 400. This functionality is accomplished by the user first selecting the lens 410 through a point and click operation. Then, the user points to a point within the lens 410 that is other than a point lying on a lens control icon 450, 412, 411, 421, 481, 482, 491, 440. When the cursor 401 is so located, a move icon 460 is displayed over the lens 410 to replace the cursor 401 or may be displayed in combination with the cursor 401. The move icon 460 not only informs the user that the lens 410 may be moved, but also provides the user with indications as to what movement operations are possible for the selected lens 410. For example, the move icon 460 may include arrowheads indicating up, down, left, and right motion. Next, the lens 410 is moved by a click and drag operation in which the user clicks and drags the lens 410 to the desired position on the screen 340 and then releases the mouse button 310. The lens 410 is locked in its new position until a further pickup and move operation is performed.

Lateral movement of a lens 410 is also provided by the pickup lens control element of the GUI 400. This functionality is accomplished by the user first selecting the lens 410 through a point and click operation. As mentioned above, when the lens 410 is selected a pickup icon 450 is displayed over the lens 410 near the centre of the lens 410. Typically, the pickup icon 450 will be a crosshairs. In addition, a lens outline icon 412 is displayed over the lens 410 representing the perimeter of the lens 410 (i.e., the perimeter of the shoulder region 430). The crosshairs 450 and lens outline 412 not only inform the user that the lens has been selected, but also provides the user with an indication as to the pickup operation that is possible for the selected lens 410. Next, the user points at the crosshairs 450 with the cursor 401. Then, the lens outline 412 is moved by a click and drag operation in which the user clicks and drags the crosshairs 450 to the desired position on the screen 340 and then releases the mouse button 310. The full lens 410 is then moved to the new position and is locked there until a further pickup operation is performed. In contrast to the move operation described above, with the pickup operation, it is the lens outline 412 that the user repositions rather than the full lens 410.

Resizing of the shoulder region 430 of a lens 410 is provided by the resize shoulder region lens control element of the GUI. After the lens 410 is selected, a bounding rectangle icon 411 is displayed surrounding the shoulder region 430. For a rectangular shaped shoulder region 430, the bounding rectangle icon 411 may be coextensive with the perimeter of the shoulder region 430. The bounding rectangle 411 includes handles 491. These handles 491 can be used to stretch the shoulder region 430 taller or shorter, wider or narrower, or proportionally larger or smaller. The corner handles 491 will keep the proportions the same while changing the size. The middle handles (not shown) will make the shoulder region 430 taller or shorter, wider or narrower. Resizing the shoulder region 430 by the corner handles 491 will keep the shoulder region 430 in proportion. Resizing the shoulder region 430 by the middle handles will change the proportions of the shoulder region 430. That is, the middle handles change the aspect ratio of the shoulder region 430 (i.e., the ratio between the height and the width of the bounding rectangle 411 of the shoulder region 430). When a user points at a handle 491 with the cursor 401 a resize icon 490 may be displayed over the handle 491 to replace the cursor 401 or may be displayed in combination with the cursor 401. The resize icon 490 not only informs the user that the handle 491 may be selected, but also provides the user with indications as to the resizing operations that are possible with the selected handle. For example, the resize icon 490 for a corner handle 491 may include arrows indicating proportional resizing. The resize icon (not shown) for a middle handle may include arrows indicating width resizing or height resizing. After pointing at the desired handle 491 the user would click and drag the handle 491 until the desired shape and size for the shoulder region 430 is reached. Once the desired shape and size are reached, the user would release the mouse button 310. The shoulder region 430 of the lens 410 is then locked in its new size and shape until a further resize shoulder region operation is performed.

Resizing of the focal region 420 of a lens 410 is provided by the resize focal region lens control element of the GUI. After the lens 410 is selected, abounding rectangle icon 421 is displayed surrounding the focal region 420. For a rectangular shaped focal region 420, the bounding rectangle icon 421 may be coextensive with the perimeter of the focal region 420. The bounding rectangle 421 includes handles 481, 482. These handles 481,482 can be used to stretch the focal region 420 taller or shorter, wider or narrower, or proportionally larger or smaller. The corner handles 481 will keep the proportions the same while changing the size. The middle handles 482 will make the focal region 420 taller or shorter, wider or narrower. Resizing the focal region 420 by the corner handles 481 will keep the focal region 420 in proportion. Resizing the focal region 420 by the middle handles 482 will change the proportions of the focal region 420. That is, the middle handles 482 change the aspect ratio of the focal region 420 (i.e., the ratio between the height and the width of the bounding rectangle 421 of the focal region 420). When a user points at a handle 481, 482 with the cursor 401 a resize icon 480 may be displayed over the handle 481, 482 to replace the cursor 401 or may be displayed in combination with the cursor 401. The resize icon 480 not only informs the user that a handle 481, 482 may be selected, but also provides the user with indications as to the resizing operations that are possible with the selected handle. For example, the resize icon 480 for a corner handle 481 may include arrows indicating proportional resizing. The resize icon 480 for a middle handle 482 may include arrows indicating width resizing or height resizing. After pointing at the desired handle 481, 482, the user would click and drag the handle 481, 482 until the desired shape and size for the focal region 420 is reached. Once the desired shape and size are reached, the user would release the mouse button 310. The focal region 420 is then locked in its new size and shape until a further focus resize operation is performed.

Folding of the focal region 420 of a lens 410 is provided by the fold control element of the GUI. In general, control of the degree and direction of folding is accomplished by a click and drag operation on a point 471, other than a handle 481, 482, on the bounding rectangle 421 surrounding the focal region 420. The direction of folding is determined by the direction in which the point 471 is dragged. The degree of folding is determined by the magnitude of the translation of the cursor 401 during the drag. In general, the direction and degree of folding corresponds to the relative displacement of the focal region 420 with respect to the shoulder region 430. In particular, after the lens 410 is selected, a bounding rectangle icon 421 is displayed surrounding the focal region 420. The bounding rectangle 421 includes handles 481,482. When a user points at a point 471, other than a handle 481, 482, on the bounding rectangle 421 surrounding the focal region 420 with the cursor 401, a fold icon 470 may be displayed over the point 471 to replace the cursor 401 or may be displayed in combination with the cursor 401. The fold icon 470 not only informs the user that a point 471 on the bounding rectangle 421 may be selected, but also provides the user with indications as to what fold operations are possible. For example, the fold icon 470 may include arrowheads indicating up, down, left, and right motion. By choosing a point 471, other than a handle 481, 482, on the bounding rectangle 421 a user may control the degree and direction of folding. To control the direction of folding, the user would click on the point 471 and drag in the desired direction of folding. To control the degree of folding, the user would drag to a greater or lesser degree in the desired direction of folding. Once the desired direction and degree of folding is reached, the user would release the mouse button 310. The lens 410 is then locked with the selected fold until a further fold operation is performed.

Magnification (i.e., elevation) of the lens 410 is provided by the magnify lens control element of the GUI. After the lens 410 is selected, the magnify control is presented to the user as a slide bar icon 440 near or adjacent to the lens 410 and typically to one side of the lens 410. Sliding the bar 441 of the slide bar 440 results in a proportional change in the magnification of the lens 410. The slide bar 440 not only informs the user that magnification of the lens 410 may be selected, but also provides the user with an indication as to what level of magnification is possible. The slide bar 440 includes a bar 441 that may be slid up and down, or left and right, to adjust and indicate the level of magnification. To control the level of magnification, the user would click on the bar 441 of the slide bar 440 and drag in the direction of desired magnification level. Once the desired level of magnification is reached, the user would release the mouse button 310. The lens 410 is then locked with the selected magnification until a further magnification operation is performed. In general, the focal region 420 is an area of the lens 410 having constant magnification (e.g., for a focal region 420 that is the flat rectangular top of a lens having a truncated pyramid shape). Magnification of the focal region 420 varies inversely with the distance from the focal region 420 to the view plane. Magnification of areas lying in the shoulder region 430 of the lens 410 also varies inversely with their distance from the view plane. Thus, magnification of areas lying in the shoulder region 430 will range from unity at the perimeter (e.g., 412) of the shoulder region 430 to the level of magnification of the focal region 420 (e.g., for a shoulder region 430 that comprises the four inclined trapezoidal sides of a lens having a truncated pyramid shape).

Zoom functionality is provided by the zoom lens control element of the GUI. The zoom lens control element allows a user to quickly navigate to a region-of-interest within an original image and then zoom in to that region-of-interest for detailed viewing or editing. Referring to FIG. 5, the combined presentation area covered by the focal region 420 and shoulder region 430 may be referred to as the “extent of the lens”. Similarly, the presentation area covered by the focal region 420 may be referred to as the “extent of the focal region”. The extent of the lens may be indicated to a user by a shoulder region bounding rectangle 411 when the lens 410 is selected. The extent of the lens may also be indicated by an arbitrarily shaped figure that bounds or is coincident with the perimeter (e.g., 412) of the shoulder region 430. Similarly, the extent of the focal region may be indicated by a focal region bounding rectangle 421 or arbitrarily shaped figure. The zoom lens control element allows a user to: (a) “zoom in” to the extent of the focal region such that the extent of the focal region fills the display screen 340 (i.e., “zoom to focal region extent”); (b) “zoom in” to the extent of the lens such that the extent of the lens fills the display screen 340 (i.e., “zoom to lens extent”); or, (c) “zoom in” to the area lying outside of the extent of the focal region such that the area without the focal region is magnified to the same level as the extent of the focal region (i.e., “zoom to scale”).

In particular, after the lens 410 is selected, a bounding rectangle icon 411 is displayed surrounding the shoulder region 430 and a bounding rectangle icon 421 is displayed surrounding the focal region 420. Zoom functionality is accomplished by the user first selecting the zoom icon 495 through a point and click operation When a user selects zoom functionality, a zoom cursor icon 496 may be displayed to replace the cursor 401 or may be displayed in combination with the cursor 401. The zoom cursor icon 496 provides the user with indications as to what zoom operations are possible. For example, the zoom cursor icon 496 may include a magnifying glass. By choosing a point within the extent of the focal region, within the extent of the lens, or without the extent of the lens, the user may control the zoom function. To zoom in to the extent of the focal region such that the extent of the focal region fills the display screen 340 (i.e., “zoom to focal region extent”), the user would point and click within the extent of the focal region. To zoom in to the extent of the lens such that the extent of the lens fills the display screen 340 (i.e., “zoom to lens extent”), the user would point and click within the extent of the lens. Or, to zoom in to the presentation area without the extent of the focal region, such that the area without the extent of the focal region is magnified to the same level as the extent of the focal region (i.e., “zoom to scale”), the user would point and click without the extent of the lens. After the point and click operation is complete, the presentation is locked with the selected zoom until a further zoom operation is performed.

Alternatively, rather than choosing a point within the extent of the focal region, within the extent of the lens, or without the extent of the lens to select the zoom function, a zoom function menu with multiple items (not shown) or multiple zoom function icons (not shown) may be used for zoom function selection. The zoom function menu may be presented as a pull-down menu. The zoom function icons may be presented in a toolbar or adjacent to the lens 410 when the lens is selected. Individual zoom function menu items or zoom function icons may be provided for each of the “zoom to focal region extent”, “zoom to lens extent”, and “zoom to scale” functions described above. In this alternative, after the lens 410 is selected, a bounding rectangle icon 411 may be displayed surrounding the shoulder region 430 and a bounding rectangle icon 421 may be displayed surrounding the focal region 420. Zoom functionality is accomplished by the user selecting a zoom function from the zoom function menu or via the zoom function icons using a point and click operation. In this way, a zoom function may be selected without considering the position of the cursor 401 within the lens 410.

The concavity or “scoop” of the shoulder region 430 of the lens 410 is provided by the scoop lens control element of the GUI. After the lens 410 is selected, the scoop control is presented to the user as a slide bar icon (not shown) near or adjacent to the lens 410 and typically below the lens 410. Sliding the bar (not shown) of the slide bar results in a proportional change in the concavity or scoop of the shoulder region 430 of the lens 410. The slide bar not only informs the user that the shape of the shoulder region 430 of the lens 410 may be selected, but also provides the user with an indication as to what degree of shaping is possible. The slide bar includes a bar that may be slid left and right, or up and down, to adjust and indicate the degree of scooping. To control the degree of scooping, the user would click on the bar of the slide bar and drag in the direction of desired scooping degree. Once the desired degree of scooping is reached, the user would release the mouse button 310. The lens 410 is then locked with the selected scoop until a further scooping operation is performed.

Advantageously, a user may choose to hide one or more lens control icons 450, 412, 411, 421, 481, 482, 491, 440, 495 shown in FIG. 5 from view so as not to impede the user's view of the image within the lens 410. This may be helpful, for example, during an editing or move operation. A user may select this option through means such as a menu, toolbar, or lens property dialog box.

In addition, the GUI 400 maintains a record of control element operations such that the user may restore pre-operation presentations. This record of operations may be accessed by or presented to the user through “Undo” and “Redo” icons 497, 498, through a pull-down operation history menu (not shown), or through a toolbar.

For example, in order to view a selected region-of-interest in detail, a user can define a lens 410 over the region-of-interest using the GUI 400. The lens 410 may be introduced to the original image to form the a presentation through the use of a pull-down menu selection, tool bar icon, etc. Using lens control elements for the GUI 400, such as move, pickup, resize base, resize focus, fold, magnify, zoom, and scoop, as described above, the user adjusts the lens 410 for detailed viewing of the region-of-interest. Using the magnify lens control element, for example, the user may magnify the focal region 420 of the lens 410 to pixel quality resolution revealing detailed information pertaining to the selected region-of-interest. That is, the portion of the original image outside the extent of the lens is displayed at a low resolution while the portion of the original image within the extent of the lens is displayed at a resolution based on a user selected magnification 440, 441.

Moreover, the lens 410 may be added to the presentation before or after the region-of-interest is selected. That is, the user may first add a lens 410 to a presentation or the user may move a pre-existing lens into place over the selected region-of-interest. The lens 410 may be introduced to the original image to form the presentation through the use of a pull-down menu selection, tool bar icon, etc.

Advantageously, by using a detail-in-context lens 410, a user can view a large area (i.e., outside the extent of the lens 410) while focusing in on a smaller area (i.e., within the focal region 420 of the lens 410) including and/or surrounding the selected region-of-interest. This makes it possible for a user to view the region-of-interest in detail without losing visibility or context of the portion of the original image surrounding the region-of-interest.

Aspects of the above described method may be summarized with the aid of a flowchart.

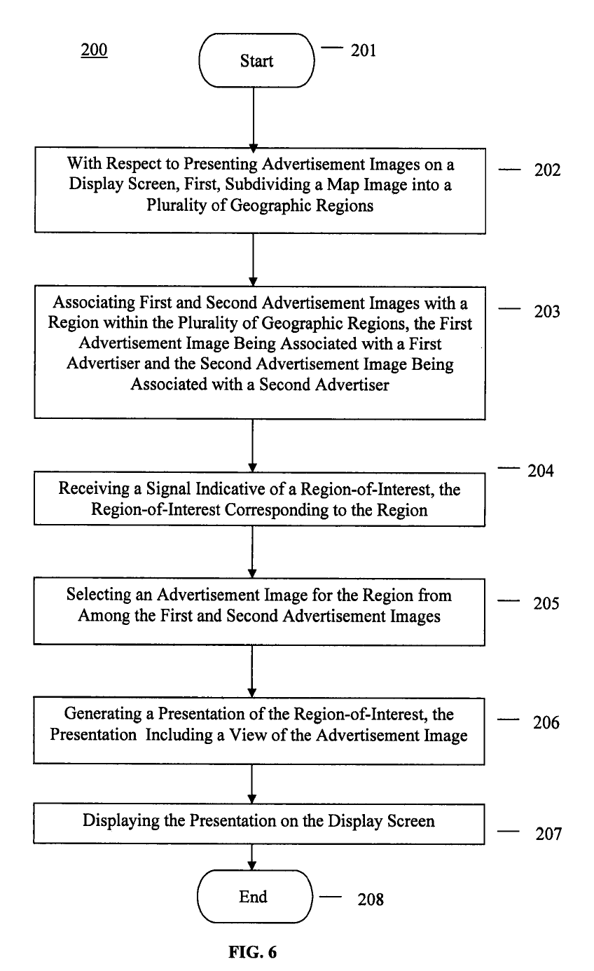

FIG. 6 is a flow chart illustrating operations 200 of modules 321, 331 within a data processing system 300 for presenting advertisement images 510, 511 on a display screen 340, in accordance with an embodiment of the invention.

At step 201, the operations 200 start.

At step 202, a map image 530 is subdivided into a plurality of geographic regions 560.

At step 203, first and second advertisement images 510, 511 are associated with a region 520 within the plurality of geographic regions 560, the first advertisement image 510 being associated with a first advertiser and the second advertisement image 511 being associated with a second advertiser.

At step 204, a signal indicative of a region-of-interest 521 is received, the region-of-interest 521 corresponding to the region 520.

At step 205, an advertisement image (e.g., 510) is selected for the region 520 from among the first and second advertisement images 510, 511.

At step 206, a presentation 500 of the region-of-interest 521 is generated, the presentation 500 including a view (e.g., 540) of the advertisement image 510.

At step 207, the presentation 500 is displayed on the display screen 340.

At step 208, the operations 200 end.

In the above method, the selecting 205 may include determining the lesser of: a first distance between the region 520 and a first location associated with the first advertiser; and, a second distance between the region 520 and a second location associated with the second advertiser. The selecting 205 may include determining the lesser of: a first number of regions associated with the first advertiser; and, a second number of regions associated with the second advertiser. The selecting 205 may include determining which of a first number of regions associated with the first advertiser and a second number of regions associated with the second advertiser does not exceed a maximum allowable number of regions. The maximum allowable number of regions may be a maximum allowable number of adjacent regions. The region 520 may include the region-of-interest 521. And, the first and second advertisement images 510, 511 may be a plurality of advertisement images and the first and second advertisers may be a respective plurality of advertisers.

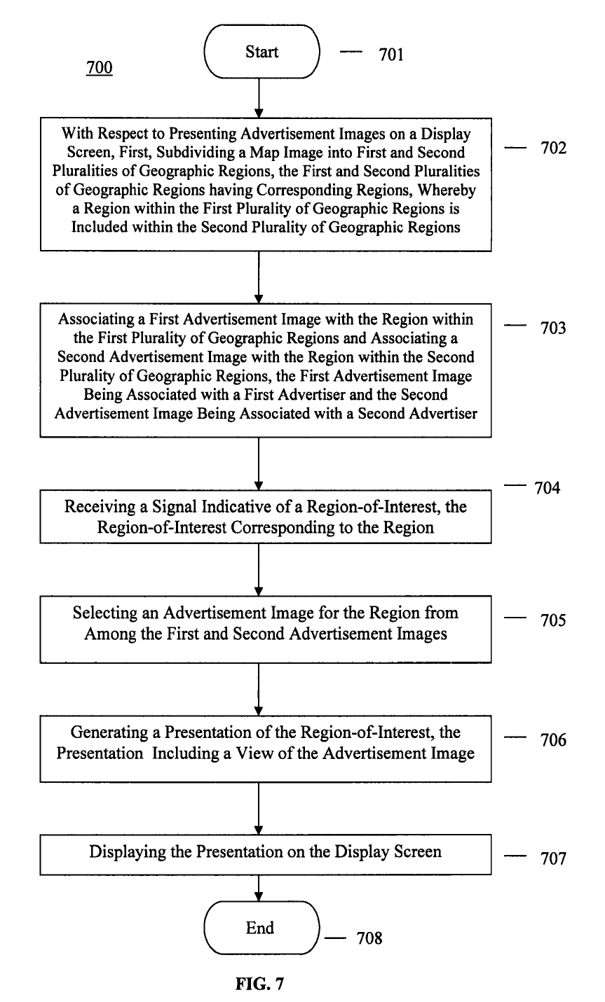

FIG. 7 is a flow chart illustrating operations 700 of modules 321, 331 within a data processing system 300 for presenting advertisement images 510, 511 on a display screen 340, in accordance with another embodiment of the invention.

At step 701, the operations 700 start.

At step 702, a map image 530 is subdivided into first and second pluralities of geographic regions W₁, W₂, the first and second pluralities of geographic regions W₁, W₂ having corresponding regions, whereby a region 520 within the first plurality of geographic regions W₁ is included within the second plurality of geographic regions W₂.

At step 703, a first advertisement image 510 is associated with the region 520 within the first plurality of geographic regions W₁ and a second advertisement image 511 is associated with the region 520 within the second plurality of geographic regions W₂, the first advertisement image 510 being associated with a first advertiser and the second advertisement image 511 being associated with a second advertiser.

At step 704, a signal indicative of a region-of-interest 521 is received, the region-of-interest 521 corresponding to the region 520.

At step 705, an advertisement image (e.g., 510) is selected for the region 520 from among the first and second advertisement images 510, 511.

At step 706, a presentation 500 of the region-of-interest 521 is generated, the presentation 500 including a view (e.g., 540) of the advertisement image 510.

At step 707, the presentation 500 is displayed on the display screen 340.

At step 708, the operations 700 end.

In the above method, the selecting 705 may include comparing a first probability of selection of the first plurality of geographic regions W₁ to a second probability of selection of the second plurality of geographic regions W₂. The first and second probabilities may be derived from respective relative dwell times. The selecting 705 may include determining which of a first number of regions associated with the first advertiser and a second number of regions associated with the second advertiser does not exceed a maximum allowable number of regions. The region 520 may include the region-of-interest 521. The corresponding regions may be coincident regions. And, the first and second pluralities of geographic regions W₁, W₂ may be a plurality of pluralities of geographic regions, the first and second advertisement images 510, 511 may be a plurality of advertisement images, and the first and second advertisers may be a respective plurality of advertisers.

While this invention is primarily discussed as a method, a person of ordinary skill in the art will understand that the apparatus discussed above with reference to a data processing system 300, may be programmed to enable the practice of the method of the invention. Moreover, an article of manufacture for use with a data processing system 300, such as a pre-recorded storage device or other similar computer readable medium including program instructions recorded thereon, may direct the data processing system 300 to facilitate the practice of the method of the invention. It is understood that such apparatus and articles of manufacture also come within the scope of the invention.

In particular, the sequences of instructions which when executed cause the method described herein to be performed by the data processing system 300 can be contained in a data carrier product according to one embodiment of the invention. This data carrier product can be loaded into and run by the data processing system 300. In addition, the sequences of instructions which when executed cause the method described herein to be performed by the data processing system 300 can be contained in a computer software product according to one embodiment of the invention. This computer software product can be loaded into and run by the data processing system 300. Moreover, the sequences of instructions which when executed cause the method described herein to be performed by the data processing system 300 can be contained in an integrated circuit product (e.g., a hardware module or modules 321) which may include a coprocessor or memory according to one embodiment of the invention. This integrated circuit product can be installed in the data processing system 300.

The embodiments of the invention described above are intended to be exemplary only. Those skilled in the art will understand that various modifications of detail may be made to these embodiments, all of which come within the scope of the invention.

What is claimed is:

1. A method for presenting advertisement images on a display screen, comprising:
subdividing a map image into a plurality of geographic regions;
associating first and second advertisement images with a region within the plurality of geographic regions, the first advertisement image being associated with a first advertiser and the second advertisement image being associated with a second advertiser;
receiving a signal indicative of a region-of-interest, the region-of-interest corresponding to the region;
selecting an advertisement image for the region from among the first and second advertisement images;
generating a presentation of the region-of-interest, the presentation including a view of the advertisement image; and,
displaying the presentation on the display screen.

2. The method of claim 1 wherein the selecting includes determining the lesser of: a first distance between the region and a first location associated with the first advertiser; and, a second distance between the region and a second location associated with the second advertiser.

3. The method of claim 1 wherein the selecting includes determining the lesser of: a first number of regions associated with the first advertiser; and, a second number of regions associated with the second advertiser.

4. The method of claim 1 wherein the selecting includes determining which of a first number of regions associated with the first advertiser and a second number of regions associated with the second advertiser does not exceed a maximum allowable number of regions.

5. The method of claim 4 wherein the maximum allowable number of regions is a maximum allowable number of adjacent regions.

6. The method of claim 1 wherein the region includes the region-of-interest.

7. The method of claim 1 wherein the first and second advertisement images are a plurality of advertisement images and the first and second advertisers are a respective plurality of advertisers.

8. A method for presenting advertisement images on a display screen, comprising:
subdividing a map image into first and second pluralities of geographic regions, the first and second pluralities of geographic regions having corresponding regions, whereby a region within the first plurality of geographic regions is included within the second plurality of geographic regions;
associating a first advertisement image with the region within the first plurality of geographic regions and associating a second advertisement image with the region within the second plurality of geographic regions, the first advertisement image being associated with a first advertiser and the second advertisement image being associated with a second advertiser;
receiving a signal indicative of a region-of-interest, the region-of-interest corresponding to the region;
selecting an advertisement image for the region from among the first and second advertisement images;
generating a presentation of the region-of-interest, the presentation including a view of the advertisement image; and,
displaying the presentation on the display screen.

9. The method of claim 8 wherein the selecting includes comparing a first probability of selection of the first plurality of geographic regions to a second probability of selection of the second plurality of geographic regions.

10. The method of claim 9 wherein the first and second probabilities are derived from respective relative dwell times.

11. The method of claim 8 wherein the selecting includes determining which of a first number of regions associated with the first advertiser and a second number of regions associated with the second advertiser does not exceed a maximum allowable number of regions.

12. The method of claim 8 wherein the region includes the region-of-interest.

13. The method of claim 8 wherein the corresponding regions are coincident regions.

14. The method of claim 8 wherein the first and second pluralities of geographic regions are a plurality of pluralities of geographic regions, the first and second advertisement images are a plurality of advertisement images, and the first and second advertisers are a respective plurality of advertisers.
